(19) United States
(12) Patent Application Publication
(10) Pub. No.: US 2025/0073945 A1
(43) Pub. Date: Mar. 6, 2025

(54) METHOD AND SYSTEM FOR MANUFACTURING PART WITH WATER JET CUTTING

(71) Applicant: GM GLOBAL TECHNOLOGY OPERATIONS LLC, Detroit, MI (US)

(72) Inventors: Ramaswamy Krishnamoorthy, Oshawa (CA); Christopher James Evans, Blackstock (CA); Mark Orchard, Port Perry (CA)

(73) Assignee: GM GLOBAL TECHNOLOGY OPERATIONS LLC, Detroit, MI (US)

(21) Appl. No.: 18/461,721

(22) Filed: Sep. 6, 2023

(51) Int. Cl. B26F 3/00

(52) U.S. Cl. CPC B26F 3/004

(57) ABSTRACT

A method for manufacturing a part using water jet cutting includes providing a water jet cutting system having a water cutter to define a cutting stream and having a working surface. The water jet cutting system includes at least one actuator responsive to one or more control signals from a controller to move the water cutter relative to the working surface. The method includes positioning a sacrificial material system on the working surface of the water jet cutting system and positioning a stock material adjacent to the sacrificial material system, the part to be composed of the stock material. The method includes cutting the part from the stock material using the water jet cutting system.

### INTRODUCTION

The technical field generally relates to a method and a system for manufacturing parts from a stock material, and more particularly relates to a method and a system for manufacturing parts from a stock material using water jet cutting.

Parts may be formed from a stock material for various uses, including testing of the stock material, etc. In one example, a specimen may be manufactured from stock material to be used in a test, such as a tensile test or the like, to determine a strength of the material, for example. In other examples, parts may be manufactured from the stock material. When water jet cutting is employed to manufacture the parts or specimens, water and/or an abrasive used during the water jet cutting may erode a surface of the resulting part or specimen as the part is formed or cut. In the example of the specimen being manufactured with water jet cutting, the erosion of the surface may impact the test associated with the specimen.

Accordingly, it is desirable to provide a method and system for manufacturing a part with water jet cutting, which reduces erosion of the surface of the part. Furthermore, other desirable features and characteristics of the present invention will become apparent from the subsequent detailed description and the appended claims, taken in conjunction with the accompanying drawings and the foregoing technical field and background.

### SUMMARY

According to various embodiments, provided is a method for manufacturing a part using water jet cutting. The method includes providing a water jet cutting system having a water cutter configured to define a cutting stream and having a working surface. The water jet cutting system includes at least one actuator responsive to one or more control signals from a controller to move the water cutter relative to the working surface. The method includes positioning a sacrificial material system on the working surface of the water jet cutting system and positioning a stock material adjacent to the sacrificial material system, the part configured to be composed of the stock material. The method includes cutting the part from the stock material using the water jet cutting system.

The method includes positioning the stock material between a first sheet of the sacrificial material system and a second sheet of the sacrificial material system. The first sheet is composed of a first material and the second sheet is composed of a second material. The first material and the second material are the same. The stock material is composed of a third material, and the third material is different from the first material. The method includes securing the first sheet, the stock material and the second sheet to the working surface. The first sheet has a first hardness, the second sheet has a second hardness, and the stock material has a third hardness, and the third hardness is greater than the first hardness and the second hardness. The cutting the part from the stock material using the water jet cutting system includes cutting the part from the first sheet and the second sheet and removing the first sheet and the second sheet from the part at completion of the cutting.

Also provided is a system for manufacturing a part using water jet cutting. The system includes a sacrificial material system configured to be coupled to a working surface of a water jet cutting system, and a stock material coupled to the sacrificial material system. The part is configured to be composed of the stock material. The system includes the water jet cutting system having a water cutter configured to cut the part from the sacrificial material system and the stock material.

The sacrificial material system includes a first sheet and a second sheet, the stock material has a first surface opposite a second surface, and the second sheet is coupled to the first surface of the stock material such that the stock material is positioned between the first sheet and the second sheet. The first sheet and the second sheet are coupled to the stock material so as to be removable upon completion of the part. The first sheet is composed of a first material and the second sheet is composed of a second material. The first material and the second material are the same. The stock material is composed of a third material, and the third material is different from the first material. The first sheet has a first hardness, the second sheet has a second hardness, and the stock material has a third hardness, and the third hardness is greater than the first hardness and the second hardness. The first sheet is composed of a first material, the second sheet is composed of a second material, the stock material is composed of a third material, and the first material, the second material and the third material are the same.

Further provided is a method for manufacturing a part using water jet cutting. The method includes providing a water jet cutting system having a water cutter configured to define a cutting stream and having a working surface. The water jet cutting system includes at least one actuator responsive to one or more control signals from a controller to move the water cutter relative to the working surface. The method includes positioning a first sheet of a sacrificial material system on the working surface of the water jet cutting system, and the first sheet is composed of a first material having a first hardness. The method includes positioning a stock material adjacent to the first sheet of the sacrificial material system. The part is configured to be composed of the stock material, and the stock material has a stock hardness. The method includes positioning a second sheet of the sacrificial material system on the stock material, the second sheet composed of a second material having a second hardness, and the first hardness and the second hardness are each less than the stock hardness. The method includes cutting the part from the first sheet, the stock material and the second sheet using the water jet cutting system.

The stock material has a first surface opposite a second surface, the positioning the second sheet on the stock material includes positioning the second sheet on the first surface and the positioning the stock material adjacent to the first sheet includes positioning the second surface of the stock material on the first sheet such that the stock material is sandwiched between the first sheet and the second sheet. The first material and the second material are the same, and the method includes securing the first sheet, the stock material and the second sheet to the working surface. The cutting the part from the stock material using the water jet cutting system includes removing the first sheet and the second sheet from the part at the completion of the cutting.

### BRIEF DESCRIPTION OF THE DRAWINGS

The exemplary embodiments will hereinafter be described in conjunction with the following drawing figures, wherein like numerals denote like elements, and wherein:

FIG. 1 is a schematic illustration of an exemplary system for manufacturing a part using water jet cutting, in accordance with various embodiments;

FIG. 1A is a detail view taken at 1A on FIG. 1;

FIG. 2 is a flowchart illustrating an exemplary method for manufacturing the part using water jet cutting, in accordance with various embodiments;

FIG. 3 is an environmental view that illustrates a water cutter of the system beginning to cut the part from a sacrificial material system and a stock material, in accordance with various embodiments;

FIG. 4 is an environmental view that illustrates the water cutter of the system cutting the part from the sacrificial material system and the stock material, in accordance with various embodiments;

FIG. 5 is an environmental view that illustrates the part cut from the sacrificial material system and the stock material, in accordance with various embodiments;

FIG. 6 is a photographic image of a corner of the cut part, in accordance with various embodiments, which illustrates a final geometry of the part; and

FIG. 7 is a photographic image of a first surface of the cut part, in accordance with various embodiments, which illustrates a final surface finish of an edge of the part.

### DETAILED DESCRIPTION

The following detailed description is merely exemplary in nature and is not intended to limit the application and uses. Furthermore, there is no intention to be bound by any expressed or implied theory presented in the preceding introduction, brief summary or the following detailed description. As used herein, the term module refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with any number of systems, and that the systems described herein are merely exemplary embodiments of the present disclosure.

For the sake of brevity, conventional techniques related to signal processing, data transmission, signaling, control, machine learning models, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

As used herein, the term “axial” refers to a direction that is generally parallel to or coincident with an axis of rotation, axis of symmetry, or centerline of a component or components. For example, in a cylinder or disc with a centerline and generally circular ends or opposing faces, the “axial” direction may refer to the direction that generally extends in parallel to the centerline between the opposite ends or faces. In certain instances, the term “axial” may be utilized with respect to components that are not cylindrical (or otherwise radially symmetric). For example, the “axial” direction for a rectangular housing containing a rotating shaft may be viewed as a direction that is generally parallel to or coincident with the rotational axis of the shaft. Furthermore, the term “radially” as used herein may refer to a direction or a relationship of components with respect to a line extending outward from a shared centerline, axis, or similar reference, for example in a plane of a cylinder or disc that is perpendicular to the centerline or axis. In certain instances, components may be viewed as “radially” aligned even though one or both of the components may not be cylindrical (or otherwise radially symmetric). Furthermore, the terms “axial” and “radial” (and any derivatives) may encompass directional relationships that are other than precisely aligned with (e.g., oblique to) the true axial and radial dimensions, provided the relationship is predominantly in the respective nominal axial or radial direction. As used herein, the term “about” denotes within 10% to account for manufacturing tolerances. In addition, the term “substantially” denotes within 10% to account for manufacturing tolerances.

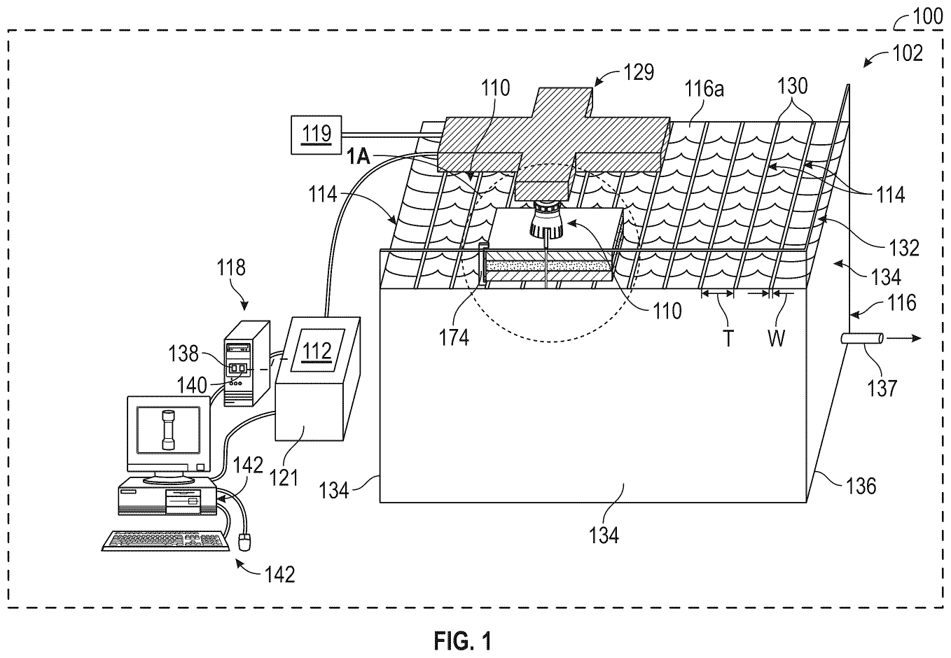

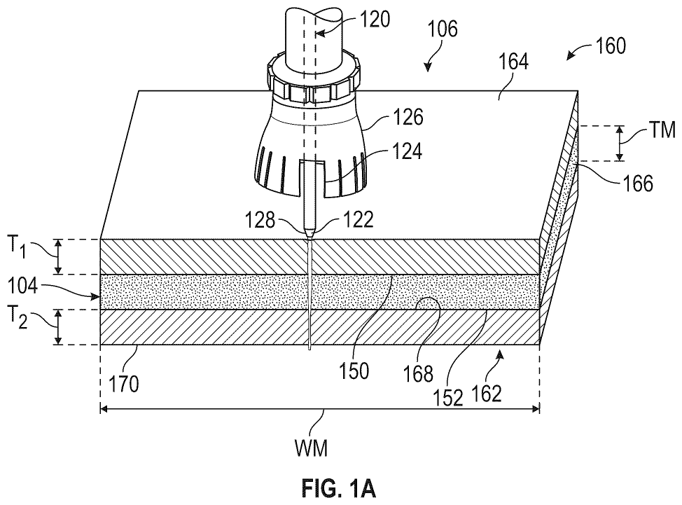

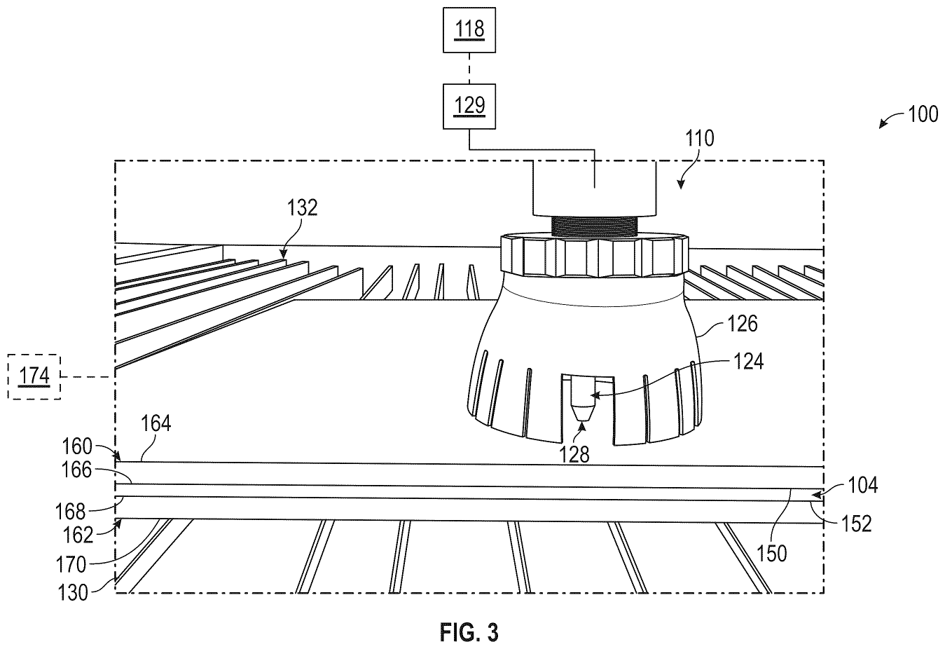

With reference to FIGS. 1 and 1A, a system for manufacturing a part using water jet cutting is shown generally as 100 in accordance with various embodiments. In one example, the system 100 includes a water jet cutting system 102, a stock material 104 and a sacrificial material system 106. As will be discussed, the system 100 enables the manufacture of a part, such as a specimen 108 (FIG. 3), with an improved surface finish and/or reduced erosion of the specimen 108 from the water jet cutting system 102. The water jet cutting system 102 comprises any suitable water jet cutting system. The water jet cutting system 102 is an abrasive water jet cutting system, but in other examples, the water jet cutting system 102 may comprise a pure-water, water jet cutting system. In one example, the water jet cutting system 102 includes a water cutter 110, at least one pump 112, a plurality of cutting supports 114, a water tank 116 and a controller 118. In this example, the water jet cutting system 102 also includes a source of abrasive material 119.

The water cutter 110 includes an inlet 120, an orifice 122, an outlet or nozzle 124 and a guard 126 (FIG. 3). The inlet 120 is in fluid communication with the pump 112 to receive water at a high pressure via conduits, hoses, tubes, etc. The inlet 120 is also in fluid communication with the source of abrasive material 119 to receive an abrasive material via conduits, hoses, tubes, etc. In one example, the source of abrasive material 119 is a hopper or tank, which stores a quantity of the abrasive material, which is fed via gravity feed, air pressure, etc. to the inlet 120. In this example, the abrasive material is a garnet abrasive, including, but not limited to ALLTEK® Garnet 80HPA abrasive, which is commercially available from Barton International of Glens Falls, NY, USA. The water and the abrasive material mix within the inlet 120. The orifice 122 is downstream of the inlet 120 and has an opening with a small diameter to further pressurize the water mixed with the abrasive material into a cutting stream 128. The cutting stream 128 exits the water cutter 110 via the nozzle 124. With additional reference to FIGS. 1A and 3, the guard 126 surrounds the nozzle 124. In this example, the guard 126 is substantially annular and cup-shaped, and is sized to surround the nozzle 124 to contain the spray associated with cutting through the stock material 104 and the sacrificial material system 106. The guard 126 may also assist in reducing splash or blow back of the cutting stream 128. In certain embodiments, with reference back to FIG. 1, the water cutter 110 may also include one or more actuators 129, which are responsive to control signals from the controller 118 to move the water cutter 110 relative to the stock material 104 and the sacrificial material system 106 to cut the specimen 108 from the stock material 104 and the sacrificial material system 106.

The pump 112 is in fluid communication with the water cutter 110 and the water tank 116. The pump 112 is a high-pressure pump for pressurizing the water from a fresh water supply 121 for use by the water cutter 110. In one example, the pump 112 may pressurize the water to about 50,000 pounds per square inch (psi) to about 80,000 pounds per square inch (psi), and as a further example, the pump 112 may pressurize the water to about 60,000 pounds per square inch (psi). The pressurized water from the pump 112 is delivered to the water cutter 110 via conduits, tubes, hoses, etc. Generally, the fresh water supply 121 may comprise any suitable source for fresh water for use by the water cutter 110 and may include a water storage tank that is fluidly coupled to the pump 112.

In this example, the plurality of cutting supports 114 comprise a plurality of slats 130. The slats 130 generally extend over an open end 116a of the water tank 116 so as to provide a working surface generally indicated as 132 for the water jet cutting system 102. Each of the slats 130 have a width W, and a thickness T. In one example, the width W is about three inches (in.). The width W of each of the slats 130 cooperates to define the working surface 132, and the thickness T is sized to provide a space between the water in the water tank 116 and the working surface 132. The slats 130 may be coupled at opposite ends to a frame, which may be positioned about or coupled to a perimeter of the water tank 116. The slats 130 are spaced apart along the working surface 132 to enable the cutting stream 128 to exit into the water tank 116.

The water tank 116 collects the water associated with the water jet cutting system 102. In one example, the water tank 116 is substantially rectangular, with four sidewalls 134 that are coupled together to define the perimeter. Each of the sidewalls 134 is interconnected or coupled to a bottom wall 136 to define a volume or receptacle to receive the water. The bottom wall 136 defines a bottom of the water tank 116 and is opposite the open end 116a of the water tank 116. In one example, the sidewalls 134 extend for about two feet (ft). The water tank 116 is in fluid communication with the cutting stream 128 and receives or collects the cutting stream 128 after the cutting stream 128 has passed through the stock material 104 and the sacrificial material system 106. The water tank 116 is in fluid communication with a drain conduit 137 to remove the water collected during the cutting operation from the water tank 116 for subsequent disposal. Optionally, the water tank 116 may also include a second pump, which is fluidly coupled to the water tank 116 and the drain conduit 137. The second pump may also be in communication with the controller 118 and responsive to one or more control signals to pump the collected water from the water tank 116 through the drain conduit 137.

The controller 118 includes at least one processor 138 and a computer-readable storage device or media 140. The processor 138 may be any custom-made or commercially available processor, a central processing unit (CPU), a graphics processing unit (GPU), an application specific integrated circuit (ASIC) (e.g., a custom ASIC implementing a neural network), a field programmable gate array (FPGA), an auxiliary processor among several processors associated with the controller 118, a semiconductor-based microprocessor (in the form of a microchip or chip set), any combination thereof, or generally any device for executing instructions. The computer readable storage device or media 140 may include volatile and nonvolatile storage in read-only memory (ROM), random-access memory (RAM), and keep-alive memory (KAM), for example. KAM is a persistent or non-volatile memory that may be used to store various operating variables while the processor 138 is powered down. The computer-readable storage device or media 140 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 118 in controlling the pump 112 and the actuators 129 of the water cutter 110.

In one example, the controller 118 is in communication with a source of data, which may be provided via a human-machine interface 142, to obtain dimensions of the specimen 108 to be cut via the water cutter 110. The human-machine interface 142 is in communication with the controller 118 via a suitable communication medium, such as a communication bus. The human-machine interface 142 may be configured in a variety of ways. In some embodiments, the human-machine interface 142 may include various input devices, such as switches or levers, one or more buttons, a touchscreen interface that may be overlaid on a display, a keyboard, a microphone associated with a speech recognition system, or various other human-machine interface devices. Generally, the human-machine interface 142 receives the data from a user, including, but not limited to data of the dimensions associated with the specimen 108. For example, the data of the specimen 108 may be designed with computer aided design (CAD) software and may include three-dimensional (3D) numeric coordinates of the entire specimen 108 including both external and internal surfaces. The instructions of the controller 118, based on the data of the specimen 108, controls the pump 112 and the actuators 129 to cut the specimen 108 out of the stock material 104 and the sacrificial material system 106. In certain instances, a speed of the actuators 129 may be reduced based on an overall thickness of the stock material 104 and the sacrificial material system 106.

The stock material 104 is the material from which the specimen 108 is composed. Generally, the stock material 104 is any material that is capable of being cut by the water cutter 110, including, but not limited to, a polymer-based material, a composite material, a metal material, a metal alloy material, etc. In one example, the stock material 104 is a metal or metal alloy, including, but not limited to aluminum or aluminum alloy. In this example, the stock material 104 is provided as a sheet or block of material, which has a thickness TM of about 0.02 inches (in.) to about 3 inches (in). The stock material 104 has a width WM, which is about 1.0 inch (in.) to about 8.0 inches (in.). It should be noted that the thickness TM and the width WM of the stock material 104 may vary based on the specimen 108 to be cut. The stock material 104 has an upstream, first surface 150 opposite a downstream, second surface 152 in a direction of flow of the cutting stream 128. The first surface 150 is proximate the nozzle 124, while the second surface 152 is proximate the slats 130. Generally, as the water cutter 110 uses water to erode through the stock material 104 to form the specimen 108, areas of the first surface 150 proximate the water cutter 110 may experience erosion if unprotected by the sacrificial material system 106. Similarly, as the cutting stream 128 exits the water cutter 110 at a high pressure, the cutting stream 128 may reflect or blowback onto the second surface 152 when the cutting stream 128 contacts the slat 130 associated with the working surface 132, for example. The reflection or blowback of the water from the cutting stream 128 back onto the second surface 152 may affect surface finish and may also result in pitting or erosion of the second surface 152 if unprotected by the sacrificial material system 106.

Thus, the sacrificial material system 106 protects the surfaces 150, 152 of the stock material 104 during cutting by the water cutter 110. In one example, the sacrificial material system 106 includes an upstream, first sheet 160 and a downstream, second sheet 162. Generally, the stock material 104 is sandwiched between the first sheet 160 and the second sheet 162 to protect the surfaces 150, 152. In one example, the first sheet 160 and the second sheet 162 are composed of a material with a hardness that is different and less than a hardness of the stock material 104. For example, the first sheet 160 and the second sheet 162 have a hardness of about 45D-55D Shore Hardness on the Shore Hardness Scale. In the example of the stock material 104 as an aluminum material, the stock material 104 has a hardness of about 10 HRB on the Rockwell B scale. In the example of the stock material 104 as steel, the stock material 104 may have a hardness of about 60 HRB on the Rockwell B scale. In this example, the first sheet 160 and the second sheet 162 are composed of medium-density fiberboard (MDF) plywood, which has the hardness that is less than the stock material 104. It should be noted that any material capable of being cut by the water cutter 110 without becoming embedded within the stock material 104 may be used with the sacrificial material system 106, including, but not limited to a polymer-based material, a composite material, a metal material, a metal alloy material, etc. In addition, in certain instances, the first sheet 160 and the second sheet 162 may be composed of the same material as the stock material 104. In the example of the first sheet 160 and the second sheet 162 composed of the same material as the stock material 104, the hardness of each of the first sheet 160, the second sheet 162 and the stock material 104 is the same. The first sheet 160 and the second sheet 162 cooperate to protect the stock material 104 during cutting of the specimen 108 using the water cutter 110. Thus, generally, the first sheet 160 and the second sheet 162 may be composed of any suitable material that has a hardness that is equal to or less than a hardness of the stock material 104.

The first sheet 160 has a first sheet surface 164 opposite a second sheet surface 166, and a first sheet thickness T1 defined between the first sheet surface 164 and the second sheet surface 166. The first sheet surface 164 is proximate the water cutter 110, and the second sheet surface 166 is adjacent to and in contact with the first surface 150 of the stock material 104. The first sheet thickness T1 is about 0.125 inches (in.) to about 0.25 inches (in.). The second sheet 162 has a third sheet surface 168 opposite a fourth sheet surface 170, and a second sheet thickness T2 defined between the third sheet surface 168 and the fourth sheet surface 170. The third sheet surface 168 is adjacent to and in contact with the second surface 152 of the stock material 104, and the fourth sheet surface 170 is adjacent to and in contact with the working surface 132 defined by the slats 130. The second sheet thickness T2 is about 0.125 inches (in.) to about 0.25 inches (in.). In this example, the first sheet thickness T1 is the same as the second sheet thickness T2, but the thicknesses T1, T2 may be different. Generally, the first sheet 160 and the second sheet 162 are consumable by the system 100 and are not reusable. The thickness of the stock material 104 and the sacrificial material system 106 is a sum of the stock thickness TM, the first sheet thickness T1 and the second sheet thickness T2.

In certain embodiments, the system 100 also includes at least one securing device 174 to secure the first sheet 160, the stock material 104 and the second sheet 162 to the working surface 132. The securing device 174 may comprise any suitable device for applying a pressure to hold, secure or fix the first sheet 160, the stock material 104 and the second sheet 162 to the working surface 132 so that the first sheet 160, the stock material 104 and the second sheet 162 do not move during the cutting of the specimen 108 by the water cutter 110. For example, the securing device 174 may include, but is not limited to, a clamp, weight, bolt, or the like to secure the first sheet 160, the stock material 104 and the second sheet 162 to the working surface 132 and/or the slats 130. In one example, the securing device 174 comprises a clamp, such as a C-clamp, which applies a pressure to the first sheet 160, the stock material 104, the second sheet 162 and to one of the slats 130 to secure the first sheet 160, the stock material 104 and the second sheet 162 to the slat 130. Alternatively, one or more large weights may be placed on the first sheet 160 to apply a pressure to secure the first sheet 160, the stock material 104 and the second sheet 162 to the working surface 132 during cutting. As a further alternative, the first sheet 160, the stock material 104 and the second sheet 162 may include bores, and a mechanical fastener, such as a bolt, may be received through the bores to secure the first sheet 160, the stock material 104 and the second sheet 162 to one of the slats 130 with a flange, bracket, nut, or the like.

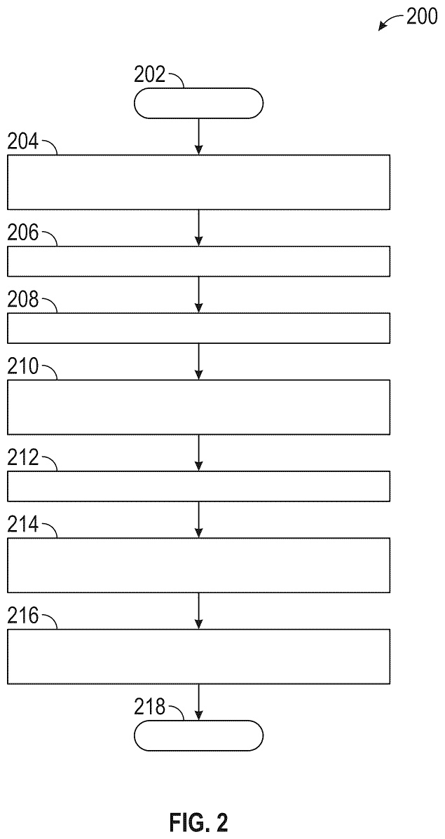

In one example, with reference to FIG. 2, and continuing reference to FIG. 1, a method 200 for cutting the specimen 108 using the system 100 is shown. Generally, the water jet cutting system 102 is assembled and ready for use before the method 200 begins. The method 200 begins at 202. At 204, the method 200 includes positioning the second sheet 162 onto the working surface 132 defined by the slats 130. At 206, the method 200 includes positioning the stock material 104 onto the second sheet 162, such that the second surface 152 is adjacent to and in contact with the third sheet surface 168. At 208, the method 200 includes positioning the first sheet 160 onto the stock material 104, such that the second sheet surface 166 is adjacent to and in contact with the first surface 150. With the stock material 104 sandwiched between the first sheet 160 and the second sheet 162, at 210, the method 200 includes securing the first sheet 160, the stock material 104 and the second sheet 162 to the working surface 132 via the securing device 174. At 212, the method 200 includes receiving data of the specimen 108, such as data of the dimensions of the specimen 108 via the human-machine interface 142, for example. At 214, the method 200 includes outputting one or more control signals to the actuators 129 of the water cutter 110, by the controller 118, to form or cut the specimen 108 based on the data of the specimen 108.

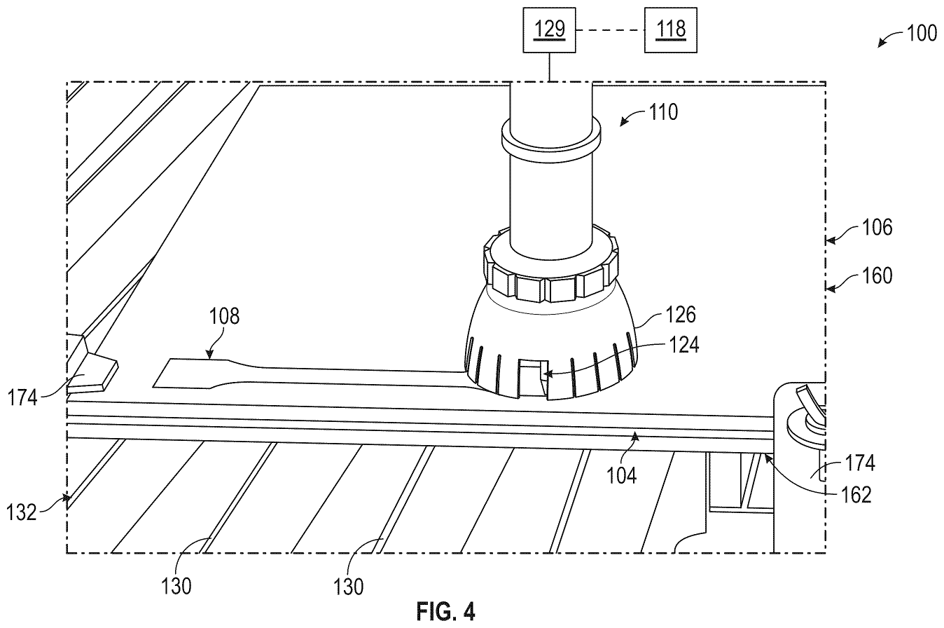

For example, with reference to FIG. 3, the water jet cutting system 102, the stock material 104 and the sacrificial material system 106 are shown in greater detail. In FIG. 3, the actuators 129 of the water cutter 110 are controlled by the controller 118 to cut the specimen 108. The guard 126 assists in containing the spray from the cutting stream 128. The second sheet 162 is positioned on the working surface 132 or the slats 130, and the stock material 104 is positioned on the second sheet 162. The first sheet 160 is positioned on the stock material 104 such that the stock material 104 is sandwiched between the first sheet 160 and the second sheet 162. The securing device 174 (FIG. 4) applies a pressure to the assembly of the first sheet 160, the stock material 104 and the second sheet 162 to secure the assembly of the first sheet 160, the stock material 104 and the second sheet 162 to the slats 130 or the working surface 132 so that the first sheet 160, the stock material 104 and the second sheet 162 are fixed or inhibited from moving relative to the working surface 132 during the cutting operation.

With reference to FIG. 4, the actuators 129 of the water cutter 110 have moved the cutting stream 128 to continue to manufacture or form the specimen 108. In this example, the specimen 108 has a dog-bone type shape for tensile testing. As shown, the first sheet 160 and the second sheet 162 protect the stock material 104 from the cutting stream 128 as the water cutter 110 cuts the specimen 108. As the first sheet 160 and the second sheet 162 are positioned on opposed sides of the stock material 104, the shape of the specimen 108 is also cut from the first sheet 160 and the second sheet 162.

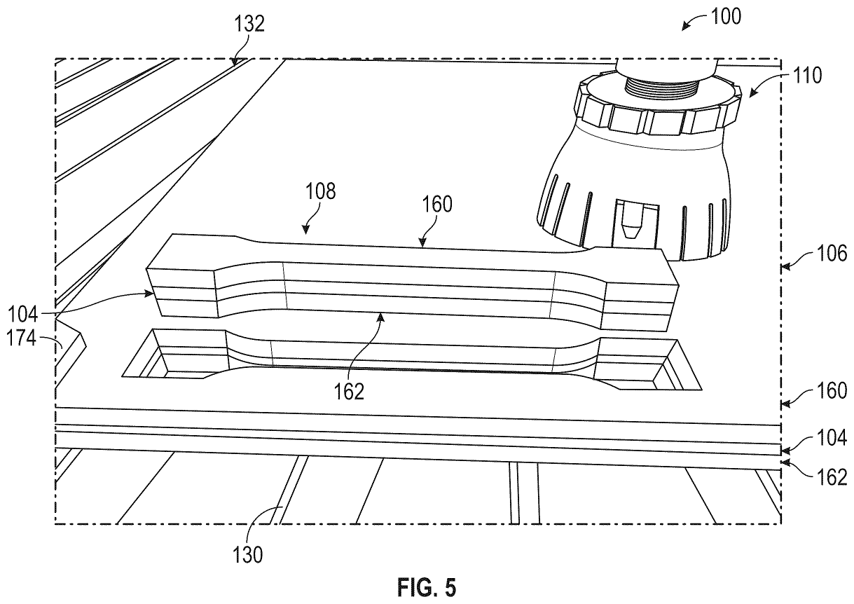

With reference to FIG. 5, the water cutter 110 has completed cutting the specimen 108 from the stock material 104 and also the first sheet 160 and the second sheet 162. With reference back to FIG. 2, at 216, the first sheet 160 and the second sheet 162 may be removed from the specimen 108 formed of the stock material 104 when the cutting operation is complete. The first sheet 160 and the second sheet 162 may be discarded, or uncut portions of the first sheet 160 and the second sheet 162 may be used to form another specimen 108. The method 200 ends at 218.

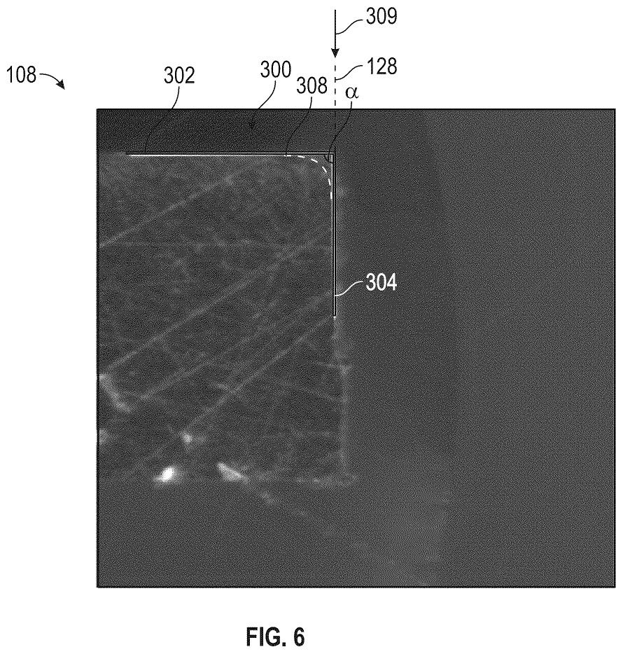

By providing the sacrificial material system 106, including the first sheet 160 and the second sheet 162, to protect the stock material 104 during the cutting of the specimen 108, the specimen 108 has improved quality. For example, with reference to FIG. 6, a photographic image shows a corner 300 of the specimen 108, which has been cut using the sacrificial material system 106. The photographic image was taken using a microscope, such as a modular stereo microscope, with a magnification of four times. The specimen 108 has a first sidewall edge 302 and a second sidewall edge 304. The first sidewall edge 302 is formed at an angle a relative to the second sidewall edge 304. The angle a is at about 90 degrees when cut with the water cutter 110 using the sacrificial material system 106. In FIG. 6, an arrow labeled 309 illustrates a direction of a flow of the cutting stream 128 to form the specimen 108, with the cutting stream 128 illustrated schematically in dashed lines. Without the sacrificial material system 106, the first sidewall edge 302 and the second sidewall edge 304 may be eroded and softened by the cutting stream 128, such that the angle a defined between the first sidewall edge 302 and the second sidewall edge 304 is not at 90 degrees. For example, the erosion may result in an arc 308 having a radius of about 0.1 millimeter (mm) being defined along the corner 300 instead of the angle α. Thus, the sacrificial material system 106 improves the resulting geometry of the cut specimen 108, which results in the specimen 108 having the geometry that matches the data provided to the controller 118.

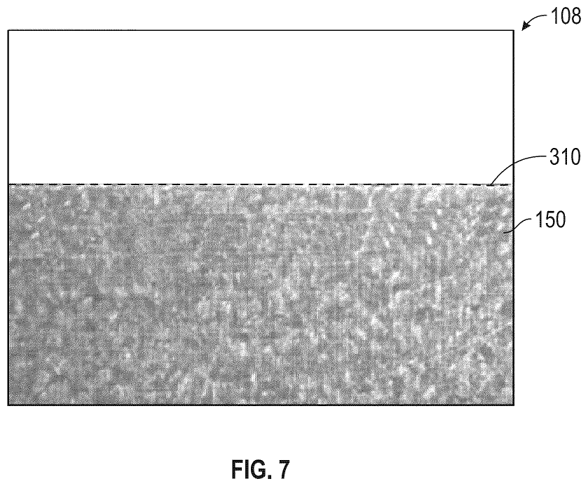

As a further example, with reference to FIG. 7, a photographic image illustrates a portion of the specimen 108 cut with the sacrificial material system 106. The photographic image was taken using a microscope, such as a modular stereo microscope, with a magnification of four times. In FIG. 7, the first surface 150 of the stock material 104 associated with the specimen 108 is shown. As shown, an edge 310 of the first surface 150 is substantially uniform. Without the sacrificial material system 106, the edge 310 may have pitting and abrasion, or show a deterioration of the first surface 150 along the edge 310 due to the contact with the cutting stream 128. The pitting and abrasion that results without the sacrificial material system 106 also leads to roughness or poor surface quality along the edge 310.

In addition, the use of the sacrificial material system 106 results in the specimen 108 cut from the stock material 104 having more accurate test results. In this regard, as the quality of the specimens 108 along with the surface finish are improved due to the use of the sacrificial material system 106, when the specimen 108 is used for testing, the test results are more accurate. For example, in specimens 108 cut without the sacrificial material system 106, it may be difficult to calculate Young's modulus after the tensile testing due to the erosion of the first surface 150. The specimen 108 cut using the sacrificial material system 106, however, has more accurate geometry and is protected from erosion by the sacrificial material system 106, which enables the calculation of Young's modulus. In addition, over multiple specimens 108 cut using the sacrificial material system 106, the standard deviation of the specimens 108 during tensile testing is about 370, in comparison to a standard deviation of about 1170 for specimens 108 cut without the sacrificial material system 106. Thus, the sacrificial material system 106 also enables the mass production of the specimens 108 with precision, in contrast to the specimens 108 produced without the sacrificial material system 106.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method for manufacturing a part using water jet cutting, comprising:
providing a water jet cutting system having a water cutter configured to define a cutting stream and having a working surface, the water jet cutting system including at least one actuator responsive to one or more control signals from a controller to move the water cutter relative to the working surface;
positioning a sacrificial material system on the working surface of the water jet cutting system;
positioning a stock material adjacent to the sacrificial material system, the part configured to be composed of the stock material; and
cutting the part from the stock material using the water jet cutting system.

2. The method of claim 1, further comprising:
positioning the stock material between a first sheet of the sacrificial material system and a second sheet of the sacrificial material system.

3. The method of claim 2, wherein the first sheet is composed of a first material and the second sheet is composed of a second material.

4. The method of claim 3, wherein the first material and the second material are the same.

5. The method of claim 4, wherein the stock material is composed of a third material, and the third material is different from the first material.

6. The method of claim 2, further comprising:
securing the first sheet, the stock material and the second sheet to the working surface.

7. The method of claim 2, wherein the first sheet has a first hardness, the second sheet has a second hardness, and the stock material has a third hardness, and the third hardness is greater than the first hardness and the second hardness.

8. The method of claim 2, wherein the cutting the part from the stock material using the water jet cutting system further comprises:
cutting the part from the first sheet and the second sheet; and
removing the first sheet and the second sheet from the part at completion of the cutting.

9. A system for manufacturing a part using water jet cutting, comprising:
a sacrificial material system configured to be coupled to a working surface of a water jet cutting system;
a stock material coupled to the sacrificial material system, the part configured to be composed of the stock material; and
the water jet cutting system having a water cutter configured to cut the part from the sacrificial material system and the stock material.

10. The system of claim 9, wherein the sacrificial material system includes a first sheet and a second sheet, the stock material has a first surface opposite a second surface, and the second sheet is coupled to the first surface of the stock material such that the stock material is positioned between the first sheet and the second sheet.

11. The system of claim 10, wherein the first sheet and the second sheet are coupled to the stock material so as to be removable upon completion of the part.

12. The system of claim 10, wherein the first sheet is composed of a first material and the second sheet is composed of a second material.

13. The system of claim 12, wherein the first material and the second material are the same.

14. The system of claim 13, wherein the stock material is composed of a third material, and the third material is different from the first material.

15. The system of claim 10, wherein the first sheet has a first hardness, the second sheet has a second hardness, and the stock material has a third hardness, and the third hardness is greater than the first hardness and the second hardness.

16. The system of claim 10, wherein the first sheet is composed of a first material, the second sheet is composed of a second material, the stock material is composed of a third material, and the first material, the second material and the third material are the same.

17. A method for manufacturing a part using water jet cutting, comprising:
providing a water jet cutting system having a water cutter configured to define a cutting stream and having a working surface, the water jet cutting system including at least one actuator responsive to one or more control signals from a controller to move the water cutter relative to the working surface;
positioning a first sheet of a sacrificial material system on the working surface of the water jet cutting system, the first sheet composed of a first material having a first hardness;
positioning a stock material adjacent to the first sheet of the sacrificial material system, the part configured to be composed of the stock material, and the stock material having a stock hardness;
positioning a second sheet of the sacrificial material system on the stock material, the second sheet composed of a second material having a second hardness, the first hardness and the second hardness less than the stock hardness; and
cutting the part from the first sheet, the stock material and the second sheet using the water jet cutting system.

18. The method of claim 17, wherein the stock material has a first surface opposite a second surface, the positioning the second sheet on the stock material comprises positioning the second sheet on the first surface and the positioning the stock material adjacent to the first sheet comprises positioning the second surface of the stock material on the first sheet such that the stock material is sandwiched between the first sheet and the second sheet.

19. The method of claim 17, wherein the first material and the second material are the same, and the method further comprises:
securing the first sheet, the stock material and the second sheet to the working surface.

20. The method of claim 17, wherein the cutting the part from the stock material using the water jet cutting system further comprises:
removing the first sheet and the second sheet from the part at completion of the cutting.
